(19) United States
(12) Patent Application Publication
(10) Pub. No.: US 2008/0123659 A1
(43) Pub. Date: May 29, 2008

(54) ARRANGEMENT AND METHOD FOR LOADING DATA INTO A MEMORY

(76) Inventors: Dirk Rosenau, Berlin (DE); Sabine Roth, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 11/772,919

(22) Filed: Jul. 3, 2007

(30) Foreign Application Priority Data
Jul. 3, 2006 (DE) 102006030979.0-53

(51) Int. Cl. H04L 12/56

(52) U.S. Cl. 370/395.7

(57) ABSTRACT

In a method and arrangement for loading data from a transmission device into a non-volatile memory of a receiver device that can be connected with the transmission device, the non-volatile memory being erased only sector-by-sector, the data to be loaded are divided by the transmission device into a number of data packets and at least one part of the data packets is loaded into the memory in a load step. A check step that is implemented before the current load step in which a current load state of the memory is checked, the current load state indicating whether at least a part of the data packets has already been successfully loaded into the memory in a preceding load step. The data packets to be loaded into the memory in the current load step are determined dependent on the current load state.

### BACKGROUND OF THE INVENTION

1. Field of the Invention

The present invention concerns a method for loading data from a transmission device into a non-volatile memory of a receiver device that can be connected with the transmission device that non-volatile memory being erasable only in segments, of the type wherein the data to be loaded are divided by the transmission device into a number of data packets and at least one part of the data packets is loaded into the memory. The present invention furthermore concerns a corresponding arrangement that is suitable for implementation of the inventive method.

2. Description of the Prior Art

A number of methods are known from the field of data processing for data transfer from a transmitter to a receiver which occur over various physical connections (known as ISO OSI Layer 1) such as, for example, RS232, IIC, Ethernet, modem, radio etc. Transfer errors that occur in the transfer of the data can be detected and even corrected since various data security layers (known as ISO OSI Layer 2) are also known. In the extreme case of transfer errors, for example due to connection interruptions, data can be repeated and a terminated connection can be reestablished. Intelligent methods can conduct a synchronization in the transfer of data so that the transfer can be continued at the point at which the interruption occurred.

In a series of electronic apparatuses (for example in franking machines), data processing units are used in a form known as embedded systems that are specifically tailored to the execution of specific functions. Memories fashioned as integrated circuits (ICs) are frequently used in these embedded systems for storage and fast reading of large data sets, with such a memory being organized in sectors. This memory is frequently based on FLASH technology. These ICs can be written (programmed) randomly and selectively, but can only be erased sector-by-sector.

If large data sets (for example the firmware of an embedded system) are transferred over a disruption-prone channel (for example a modem or a radio connection) from a transmitter to a receiver and are written into a memory of the receiver, such data are frequently transferred in compressed form in order to minimize the time for the transfer and storage. The compression is frequently not applied to the entire data set since otherwise large memory regions (which are usually not present in embedded systems) would be required for decompression. As an alternative, the data to be loaded into the memory of the receiver are initially segmented into data packets that are then compressed and subsequently transferred.

The temporal optimization of the data transfer requires that the data packets be able to be selected as to quantity independently of the sector limits of the memory of the embedded system. When the writing to the memory organized sector-by-sector is unexpectedly interrupted (for example due to interruption of the circuit), the memory region written at the point in time is in a non-deterministic state. If such an unscheduled interruption occurs, all data typically are retransmitted between the transmitter and the receiver in a new communication, which can lead to the situation that, in particular given very unstable connections, a relatively long time is required until the complete loading of the data into the memory of the receiver is accomplished.

### SUMMARY OF THE INVENTION

An object of the present invention is to provide a method and an arrangement of the aforementioned type that do not exhibit the aforementioned disadvantages, or exhibit the aforementioned disadvantages to a lesser degree, and that in particular enable in a simple manner, a time-optimized loading of data from a transmitter device into a memory of a receiver device, the memory being organized in sectors.

The present invention is based on the insight that a time-optimized loading of data from a transmitter device into a memory of a receiver device, the memory being organized in sectors, can be achieved when a current load state of the memory is checked in a check step that is implemented before resuming loading of the data, the current load state indicating whether at least a portion of the data packets have already been successfully loaded into the memory in a preceding load session, and the data packets to be loaded into the memory in the current load step are determined dependent on the current load state.

It has been shown that a simple detection of the load state of the memory is possible even for a memory organized per sector. Through this detection and the checking of the load state of the memory of the receiver device made possible thereby, in a simple manner the number of the data packets to be transmitted to the receiver device in the load step can be limited only to the absolutely necessary extent such that, different from conventional loading procedures, it is no longer required to completely transmit the data to be loaded from the transmitter device to the receiver device after a connection termination in a (normally immediately) preceding load step. The time expenditure for the transmission is thereby significantly reduced under certain circumstances.

It should be noted that the loading of the data into the memory of the receiver device in the sense of the present invention need not necessarily be for the storage of the data at its ultimate target address (i.e., in a target memory region). Rather, in addition to the target memory region the memory can have one or more further memory regions (for example one or more intermediate memory regions) into which the data are initially loaded before they are then written into the target memory region.

The determination of the data packets to be loaded thereby ensues dependent on the type or technology of the employed memory. For a memory organized in sectors that are to be erased only on a sector-by-sector basis, upon a connection interruption in a preceding load step, data packets that have already been successfully loaded into the last-written memory sector must also be erased under certain circumstances. These data packets must then be re-transmitted in order to ensure completeness of the transmitted data.

In the load step, dependent on the current load state of the memory at least one sector of the memory is preferably erased and, in addition to the data packets provided for the erased sector, exclusively those data packets which were not yet successfully loaded into the memory are transmitted and loaded into the memory. The data set to be transmitted and to be loaded is hereby reduced to a minimum in an advantageous manner.

The detection and updating of the load state can ensue at any point or points in time. For example, the load state may be detected and updated only when a connection termination and/or the complete loading of the data into the memory is detected, whereupon the corresponding load state information is stored in a non-volatile manner, for example. In an embodiment, load state information identifying the current load state of the memory is stored in a non-volatile manner in the load step after the successful loading of a data packet into the memory. The load state information can be stored at any location, but it is advantageously stored in the memory itself.

The successful complete loading of the data can be documented in any suitable manner. Preferably load state information identifying the successful conclusion of the load step is stored in the load step after the successful loading of the last data packet. A fast, later detection of the successful conclusion of the load step is thus made possible.

The detection and description of the current load state can ensue in any suitable manner. In preferred variants of the inventive method, load state information is queried to check the current load state, the load state information identifying at least one data packet successfully loaded into the memory in the preceding load step, at least in connection with a further suitable load information. Both the sector of the memory to be erased and the data packets still to be loaded then can be determined in a simple manner using this data packet.

In principle the load state information can have any suitable design and content. The load state information preferably includes at least one memory address of a data packet successfully loaded into the memory in the preceding load step, since using this memory address the appertaining data packet is particularly simple to identify.

The memory address can be any memory address within the data packet, but the load state information preferably includes a start address of a data packet successfully loaded into the memory in the preceding load step. Furthermore, the load state information preferably also includes an end address and/or a size information of this data packet successfully loaded into the memory in the preceding load step, such that it can simply be determined in an advantageous manner whether further memory sectors are still to be erased in the event that the data packet extends across multiple sectors of the memory.

In preferred variants of the invention, different versions of the data to be loaded can be detected. It is therefore preferable to make a version comparison in the check step of the version of the current data loaded in the memory and the version of the data to be loaded into the memory, and the load step is implemented only when the version of the data to be loaded into the memory is more current than the version of the current data loaded in the memory and/or a load instruction initiating the load step exists. It is thus possible to avoid an accidental re-loading of already-loaded data.

In order to ensure that only complete, authorized and/or authentic data are loaded into the memory, preferably the transmitter device associates check data with at least one part of the data to be loaded (in particular at least a portion of the data packets) before the load step, and the receiver device verifies the completeness and/or integrity and/or authenticity of the data to be loaded using the check data. Any known, suitable security mechanisms (such as CRCs, MACs (Message Authentication Codes), digital signatures etc.) can be used. Corresponding check data are advantageously associated with all data packets, such that a consistent (gap-less) verification is possible.

In preferred variants of the inventive method, at least one part of the data to be loaded is transmitted from the transmitter device to the receiver device in compressed form since a further time optimization in the transfer can thereby possibly be achieved.

In further advantageous variants of the inventive method the division of the data to be loaded into data packets in the division step ensues dependent on the connection between the transmitter device and the receiver device; in particular a compression of at least a portion of the data to be loaded can ensue. Depending on the type of the connection between the transmitter device and the receiver device and the computation capacity of the receiver device, an optimization with regard to the transfer speed can be achieved. For example, a compression can be dispensed with when the speed advantage in the transfer that is achieved by the compression is at least largely negated by the decompression in the receiver device.

According to the inventive method, in principle any data can be loaded into the memory of the receiver device. The method can be particularly advantageously used in connection with the reinstallation and/or updating of data in the receiver device. For example, this can be the exchange of firmware of the receiver device. It is therefore preferable that the data to be loaded represent at least one portion of the firmware of the receiver device.

In the load step the respective data packet can then be directly written to its ultimate position in the memory such that no further memory must be provided for a buffering of the data packets. In this case the firmware is then subdivided into a load part (known as the boot loader) and a main function part. The load part of the firmware is then fashioned such that, among other things, it can take over the communication with the transmitter device and the loading of the data packets so that the main function part of the firmware can be exchanged. This configuration is advantageous when the memory has only limited volume, such that buffering of the data is not possible. It is hereby understood that the load part then exhibits a memory space requirement corresponding to its functional extent.

In another variant of the invention, the respective data packet is first written into a buffer region of the memory in the load step. This has the advantage that the main function part of the firmware can then take over the communication with the transmitter device and the buffering of the data packets so that the load part of the firmware later must take over only the organization of the data and the exchange of the main function part. Although, this requires more memory space, the load part can be correspondingly simple and thus small.

Furthermore, it is understood that, depending on the operation mode of the receiver device, the new firmware data to be loaded can also be written directly to a new memory space without exchanging the old firmware data insofar as this new memory space is likewise established (i.e. is usable) as a memory for firmware.

In further preferred variants of the inventive method, at least the memory sector in which at least one part of the first data packet is to be loaded is erased in the load step before the loading of the first data packet. All further memory sectors to be written with the data of the remaining data packets are also advantageously erased, beginning with this memory sector.

The transmitter device can generate an erasure information dependent on the current load state of the memory, this erasure information directly identifying the memory sectors of the memory to be erased in the load step. The transmitter device then transmits the erasure information to the receiver device so that in the load step the corresponding memory sectors are erased dependent on the erasure information. This has the advantage that no computation capacity for the calculation of the memory sectors to be erased must be addressed in the receiver device, which normally has a limited computation capacity.

In other variants of the invention, the receiver device itself determines the memory sectors to be erased. This has the advantage that the transmitter device must have no knowledge about the type and/or composition of the memory, such that the data retention in the transmitter device is simplified or reduced or no corresponding communication in this regard must occur between the transmitter device and the receiver device.

If the loading of the data packets in the receiver device and the storage in the ultimate memory region are performed separately, for example if a storage of the data packets in a buffer (cache) ensues, the receiver device can be designed to detect that a data packet completely received in a preceding load step was not successfully written at its ultimate position, such that the memory sector or sectors that are provided for this data packet, that was completely received but not yet successfully stored at its ultimate position, are still also to be erased.

The erasure information can be transmitted, for example, in a transmission or packet header before the transmission of the actual data packets in the framework of the communication between the transmitter device and the receiver device.

In preferred variants of the inventive method, it is provided that the current load state is represented by load state information that, in connection with further load information, identifies at least one first data packet loaded into the memory in the preceding load step, this first data packet being the last that was successfully loaded into the memory and was written as the first data packet into a first memory sector previously erased. The erasure information then identifies at least the first memory sector.

In this manner, the load state information always contains a data block that marks a critical section in the case of a termination of the transfer from the transmitter device to the receiver device. In the event of a termination of the transfer, dependent on the load step it can be determined which data blocks must imperatively be retransferred. Since, as mentioned above, the termination of the transfer during storage of the data blocks can lead to arbitrary (thus not precisely defined) states in the last written address space, dependent on the memory technology it is required to erase the last written memory sector or memory sectors. Since the sector limits do not necessarily coincide with data block limits, under the circumstances a number of data blocks already successfully transferred are wholly or partially lost due to the erasure of memory sectors.

Since in this variant the load state always contains a data block that, as a first data block has been written into a previously erased sector and the data blocks have a defined sequence of start addresses (normally strictly monotonically increasing start addresses), this data block that is identifiable using the load state information is a safe candidate for a continuation of the transfer. In the event that it is not known which memory sectors have already been written in a preceding load step, that continuation of the transfer (thus in the current load step) can proceed with at least all memory sectors between an interim start sector and an interim end sector being erased. The interim start sector is the memory sector that has the start address of the data packet which is determined using the load state information. The interim end sector has the end address of the data packet that is to be determined using the load state information. If, as described above, all further memory sectors to be written should also be erased, the last memory sector to be erased can in turn be erased with the aid of the end address of the last data packet contained in a packet header.

It is understood that it can be sufficient for the load state information to identify the last successfully loaded data packet; a history of the successfully loaded data packets thus does not have to be provided. This can in particular be the case when re-writing can start exactly at the sector limits of the memory sectors, such that for the case of the last successfully loaded data packet extending beyond a sector limit, only the subsequent memory sector is erased and only the part of the data packet that extends beyond this memory sector is re-written into this memory sector.

If this is not the case, either a history is required that identifies at least that data packet of which the start address additionally also lies in the first memory sector. Alternatively, the load state information can identify only such data packets for which the start address of the first data packet lies in the first memory sector. This packet is then identified as a data packet which, as a first data packet, is to be written into the appertaining first memory sector and whose start address additionally lies in this first memory sector, such that for this data packet the transfer can be restarted in each case without the aforementioned problems.

The present invention furthermore concerns an arrangement for loading of data from a transmitter device into a non-volatile memory of a receiver device that can be connected with the transmitter device, the non-volatile memory being erased only in sections, wherein the transmitter device is fashioned to divide the data to be loaded into a number of data packets and the receiver device is fashioned to receive and to load at least one portion of the data packets into the memory in a load step. According to the invention the receiver device is fashioned to transmit a current load state of the memory to the transmitter device, the current load state indicating whether at least a portion of the data packets was already successfully loaded into the memory in a preceding load step. Furthermore, the transmitter device is fashioned to determine, dependent on the current load state, the data packets to be transmitted to the receiver device and/or to be loaded into the memory in the load step.

This arrangement is suitable for implementation of the inventive method. The variants and advantages described above can be realized to the same extent with this arrangement, and thus need not be repeated.

The present invention is in principle suitable for use in connection with arbitrary data processing devices in which a corresponding memory technology is used. It is in particular suitable for use in connection with the embedded systems mentioned above, and can be particularly advantageously used in connection with franking machine systems since in this context only limited computation capacity is normally present in the franking machine, and the connection with a remote data center with which updated data are provided normally ensues over comparably slow and thus disruption-susceptible communication channels (connections via modem, etc.). It is therefore preferable that the receiver device is a franking machine and/or the receiver device is a remote data center.

The present invention furthermore concerns data processing devices which exhibit all features of a transmitter device or of a receiver device of an inventive arrangement.

### BRIEF DESCRIPTION OF THE DRAWINGS

FIG. 1 is a block diagram of a preferred embodiment of the inventive arrangement for loading of data from a transmitter device into a receiver device, with which arrangement a preferred embodiment of the inventive method for loading of data from a transmitter device into a receiver device can be implemented.

FIG. 2 schematically shows the data prepared for transmission to the receiver device of FIG. 1.

FIG. 3 schematically shows a portion of the memory of the receiver device from FIG. 1.

FIG. 4A is a first part of a flowchart of a preferred embodiment of the inventive method for loading of data from a transmitter device into a receiver device, which can be implemented with the arrangement of FIG. 1.

FIG. 4B is a second part of the flowchart of the preferred embodiment of the inventive method for loading of data from a transmitter device into a receiver device, which can be implemented with the arrangement of FIG. 1.

### DESCRIPTION OF THE PREFERRED EMBODIMENTS

In the following, a preferred embodiment of the inventive arrangement 101 for loading of data from a transmitter device (in the form of a data center 102) into a receiver device (in the form of a franking machine 103) is described with reference to FIGS. 1 through 4B. With this preferred embodiment a preferred embodiment of the inventive method for loading of data is implemented. The franking machine 103 can be connected with the remote data center 102 via a communication network 104.

The franking machine 103 includes a processor 103.1 in the form of a microprocessor and a memory 103.2 connected therewith. The franking machine 103 can be connected with the communication network 104 (and therewith with the data center 102) via a modem 103.3 connected with the processor 103.1. Furthermore, the franking machine 103 comprises a printing device 103.4 by means of which franking imprints can be generated as well as a user interface 103.5 (for example display and keyboard) via which a user can, among other things, effect specific inputs in the franking machine 103.

The franking machine is a so-called embedded system that, in addition to special peripherals (display and keyboard 103.5, printer 103.4, beeper, motors, sensors, security module, modem 103.3, interfaces etc.), is composed of the basic components of processor 103.1 and memory 103.2. The memory 103.2 is logically sub-divided into a program memory, a persistent (non-volatile) memory for continuous data retention and a transient (volatile) working memory. The program memory contains instructions that are executed by the processor 103.1 and ultimately realize the functionality of the franking machine 103 in cooperation with the connected peripherals. The persistent memory holds data that are required by the franking machine 103 for realization of the functionality at all times—thus even after a shutdown procedure of the franking machine 103. The working memory is required for the operation (normally calculations) of the processor 103.1 and serves for storage of results that are necessary only for the current operation and thus are not persistently required.

As is typical of a series of such embedded systems, the portion of the memory 103.2 that serves for storage and quick reading of large data sets is an integrated circuit (IC) organized in sectors that can be written to (programmed) randomly and selectively but can only be erased per sector. In the present example this portion of the memory 103.2 is based on what is known as FLASH technology. It is understood that any other memory types organized in sectors can also be used in other variants of the invention.

Manufacturers and the users of franking machines have an interest in the continuous improvement and expansion of franking machines. In particular it is intended to already bring about these measures during the lifetime of the franking machine. Service contracts and special agreements between the users and sales or the manufacturer of the franking machine are concluded ever more frequently for this purpose.

Such improvements and expansions are normally realized via software since in this manner large effects can be achieved with a minimal cost/benefit ratio. The software is used in an embedded system, in the franking machine 103, and is designated as firmware. The firmware does not necessarily have to be executable software as is known from conventional PCs. It can also be complex data or information that are ultimately processed inside the embedded system. Not least, a firmware can also be arbitrary combinations of such data.

Among other things, the memory 103.2 has a first memory region 103.6 (designated as program memory or firmware memory) that is in turn subdivided into a second memory region 103.7 and a third memory region 103.8 and comprises a fourth memory region 103.9 designated as a buffer. The second memory region 103.7 is provided to accept a load part (known as the boot loader) of the firmware of the franking machine 103. The third memory region 103.8 serves to accept a main function part of the firmware of the franking machine 103. The functions of the load part 103.7 and of the main function part 103.8 are described in detail in the following.

A typical variant of the manufacture of circuit boards for embedded systems is based on a mounting method in which the components are soldered onto the surface of a circuit board. An exchange of firmware of such an embedded system via a physical intervention in the system (for example via the exchange of components) is often no longer profitable for the manufacturers and the clients for cost reasons, however also ever more frequently for process reasons. The costs for memory components simultaneously, steadily decrease and the methods for implementation of more complex applications on embedded systems become more efficient, such that it is technically possible without high costs to exchange firmware via the inventive method without physical interventions, as this should be described here in the example of the franking machine 103.

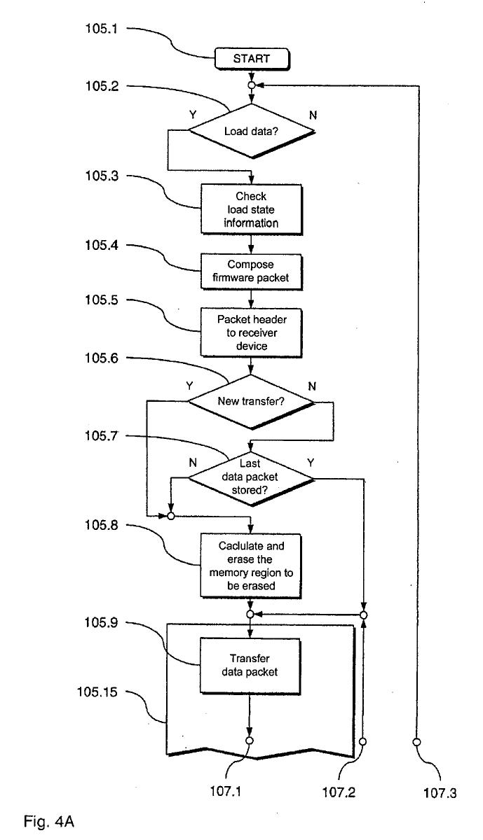

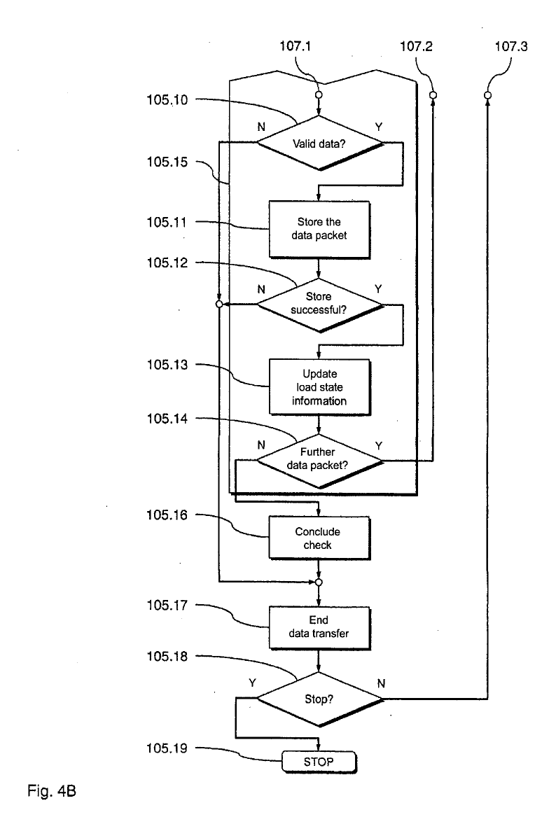

As can be seen from FIG. 4A, the method workflow is initially started in a step 105.1. In a step 105.2 it is then checked whether corresponding data (thus firmware in the present example) should be loaded from the data center 102 into the franking machine 103. This check can occur, for example, in the framework of a routine communication between the franking machine 103 and the data center 102.

The loading of the data can thereby be initiated both by the data center 102 and by the franking machine 103. For example, it is possible that, in the case of an updating of the firmware that is provided for the appertaining franking machine 103, the data center 102 automatically initiates the exchange of the firmware of the franking machine 103 (i.e. without further action by the user of the franking machine 103) upon the next contact of the franking machine 103 with the data center 102. Naturally, a corresponding communication with the data center 102 can likewise also be initiated (for example at a corresponding input of the user of the franking machine 103), in the framework of which communication an exchange of the firmware is requested on the part of the franking machine 103.

In the present example the exchange (thus the loading of the firmware from the data center 102 into the franking machine 103) should ensue via the modem 103.3. Due to the comparably disruption-prone transfer channel and the frequently long transfer time given large data sets (data quantities), connection interruptions (in particular also due to external deliberate or unintended intervention of the user of the franking machine 103) are to be expected to a particular extent. As is explained in detail in the following, the disadvantages connected with such a connection interruption are countered via the present invention.

It is understood that the franking machine 103 in principle also enables the exchange of firmware via corresponding different interfaces. For example, it can thus be provided that the firmware is loaded into the franking machine 103 from the PC of a service technician that is connected with the franking machine 103 via a corresponding interface.

In the present example the franking machine 103 also enables for the user the exchange of its firmware without the intervention of a service technician and the expenditure connected with this. In the present example a service is thus started through an input or, respectively, an actuation by the user via a special menu prepared for this purpose or via what is known as a softkey, in the course of which service the communication with the data center 102 is established and the firmware is then exchanged.

In order to allow the firmware of the franking machine 103 to be exchanged, it is initially suitably, logically grouped and (for simplicity) normally also stored in the memory 103.2, but this is not absolutely necessary. For example, the postage tables and the print image description typically reside in a predefined region in persistent memory. A more precise grouping (for example of the print image description) is reasonable, however is not shown in this exemplary embodiment.

The program memory 103.6 was likewise logically grouped, namely in the memory region 103.7 for the load part or, respectively, load instruction part of the firmware and the memory region 103.8 for the main function part of the firmware. However, it is understood that any other division into more than only two function parts is also possible in other variants of the invention.

In the present example the load instruction part comprises instructions for communication via the interfaces of the franking machine 103 to receive the firmware, instructions for programming or, respectively, reorganization of the memory 103.2, instructions for verification of received data (for example of a main function part to be exchanged) and instructions for starting the main function part.

The main function part of the firmware comprises all remaining instructions and constant data for the processor 103.1 that are necessary to implement the functionality planned for the franking machine 103 (for example menu control, letter detection and transport, franking, billing etc.).

In the present example, the load instruction part is grouped such that it is optimally small in size but is powerful enough in its functional scope to be able to exchange the main function part.

A sub-division that can be transferred in a time-optimized manner typically does not result from this grouping of the firmware, since the created instructions are normally strongly redundant and often instructions and constants are placed such that they are separated by gaps.

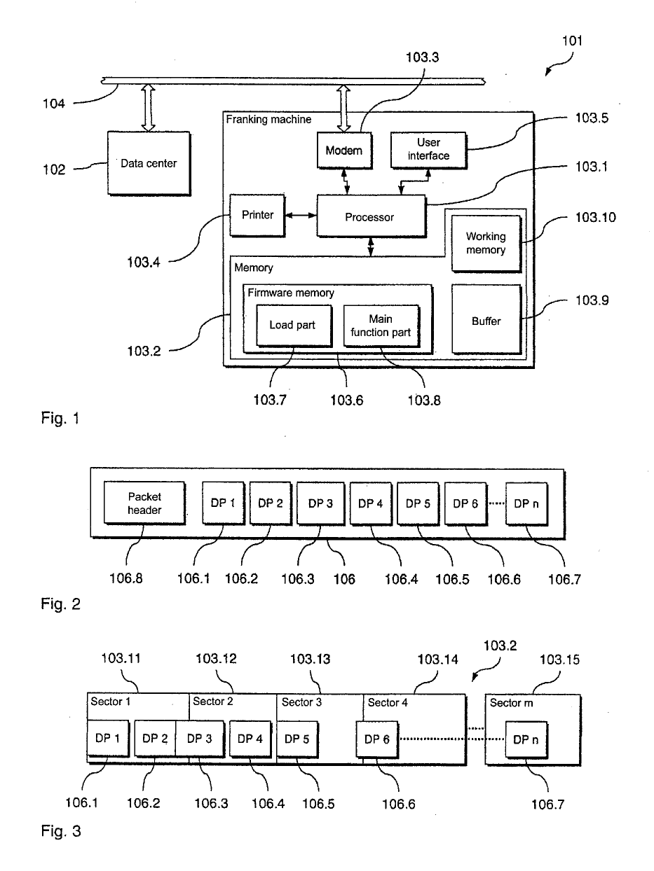

To exchange the firmware, a specific firmware packeting is therefore initially effected in a data center 102 (consequently thus outside of the franking machine 103) in a division step. The firmware is thereby divided into n data blocks or data packets 106.1 to 106.2 (see FIG. 2) that can respectively be completely loaded into the working memory 103.10 of the franking machine 103.

Since the physical position of the firmware (segmentation) is also established by the grouping of the firmware in the present example, for each data block 106.1 through 106.7 its target address and size is set as a prefix. Alternatively, target address and end address could also be specified. The data block 106.1 through 106.7 can optionally contain additional check data (for example CRC) to improve the transfer security. The data block can optionally be compressed in the event that this leads to an increase of the throughput given the transfer speed to be expected between the data center 102 and the franking machine 103.

In the packeting process an optimum for the data throughput is aimed for. The compression rate, the size of the available working memory 103.10 of the franking machine 103 and the segmentation of the firmware must thereby be taken into account. Furthermore, the computation capacity of the franking machine 103 may be taken into account at least as far as the compression rate is concerned.

A packet header 106.8 that comprises the start address and end address of the firmware, its size and other data for description and securing of the firmware is generated as a last process step of the packeting.

In order to be able to ensure the security for the manufacturers and the clients (and, in the present example of a franking machine, also for the postal carriers), the firmware is preferably only exchanged in an authorized and secured manner. This is achieved by every firmware packet 106, which contains the packet header 106.8 and a sequence of data packets 106.1 through 106.7, likewise includes in the packet header 106.8 check data (for example a message authentication code (MAC), a digital signature or the like) and identification data (for example the version number of the firmware).

The evaluation of such data enables the firmware to be selectively exchanged, whereby via the verification of check data, for example via verification of a digital signature, the franking machine can ensure that only firmware provided with a valid signature (and therewith authorized) is loaded.

Through identifier data in the form of version information, various versions of a loadable firmware can be held ready on call by a server of the data center 102 as files in a file system or a database and be distributed as needed.

After the connection is established, the franking machine 103 initially transmits a service indicator that starts the corresponding service for firmware exchange on the server of the data center 102 and subsequently lets the server take over the control over the continuing service for firmware exchange.

In a step 105.3 the server initially reads from the franking machine 103 various status information that are necessary for the firmware exchange. These are, for example, the present identifier data of the current firmware loaded in the franking machine 103, the last load status or load state in the form of load state information and an identification which identifies the franking machine 103 or, respectively, the users associated with it. Dependent on the strategy or method implemented in the server of the data center 102, further data can be read out from the franking machine 103, which further data then lead to the situation that a suitable new firmware is selected by the server of the data center 102 for exchange.

In a check step of the step 105.3, the server of the data center 102 checks the current load state of the franking machine 103 using the load state information. Using the load state information (described in further detail in the following with regard to its content), the server can thereby establish whether a portion of the data packets 106.1 through 106.7 to be loaded in the framework of the current service have already been successfully loaded into the memory 103.2, for example in the course of an interrupted previous communication between the data center 102 and the franking machine 103, i.e. a communication that was not successfully concluded. For this purpose, the load state information comprises the start address of the data packet that was last successfully transmitted to the franking machine 103.

If this is the case, in a step 105.4 the appertaining firmware packet 106 is reduced by a suitable number of data packets 106.1 through 106.7 in that those data packets are extracted that have already been successfully transmitted and stored. In the present example, these data packets all have a start address that has a predetermined relation to the start address (contained in the load state information) of the last successfully transmitted data packet.

Depending on the organization of the start addresses of the data packets 106.1 through 106.7, this relation can be arbitrarily predetermined. In the present example, the data packets extracted from the firmware packet 107 all have a start address that is smaller than the start address (contained in the load state information) of the last successfully transmitted data packet.

The data packets that are no longer to be transmitted are extracted from the sequence of the data packets 106.1 through 106.7. The packet header 106.8 of the firmware packet 106 is subsequently expanded with information that identifies a continuation of a preceding transfer procedure.

As is described in detail in the following, the data sequence remaining as a firmware packet 106 is subsequently transmitted to the franking machine 103, whereby each message from the franking machine 103 must be positively confirmed by a return message so that the transfer can be continuously successfully executed.

In the event that the last executed exchange was not interrupted, this is likewise to be learned from the load state information. In this case the packet header 106.8 of the firmware packet 106 is expanded by information that identifies a new transfer. The firmware packet 106 with the sequence of the data packets 106.1 through 106.7 is then transferred unabbreviated.

Given connection interruptions during the loading of the firmware into the franking machine 103, in this manner a shorter transfer time can obviously be achieved than given the previously used methods in which in principle the entire firmware was re-transferred in such cases.

A suitable selection of the start address contained in the load state information as well as the optimal administration of the written sectors of the non-volatile portion of the memory 103.2 is important for the completeness of the loaded firmware and thus also for the successful verification of the firmware by the franking machine 103.

As a simplification, in the present example it is assumed that the data packets 106.1 through 106.7 of the firmware packet are arranged such that the addresses of the data are strongly monotonically increasing. This makes the data retention of the load state or, respectively, of the load state information easier and brings no significant disadvantages. It is understood that any arbitrarily different predetermined sequence of the addresses of the data of the firmware packet can exist in other variants of the invention.

A particularly advantageous variant of the determination of the start address of the load state information is explained in the following with reference to FIG. 3. FIG. 3 exemplarily shows the design of a persistent memory 103.2 divided into memory sectors 103.11 through 103.15 of different sizes. FIG. 3 furthermore shows how the data blocks 106.1 through 106.7 of the firmware are placed.

As can be seen from FIG. 3, a large gap exists between the firmware packet 106.5 (DP 5) and the data packet 106.6 (DP 6), for example, due to the grouping into various data blocks effected for time-optimized transfer of the firmware. A transfer of data of these gaps is not reasonable since the data would obviously never be used. The data packet 106.2 (DP 2) and the data packet 106.3 (DP 3) lie close to one another. Since no gap is to be detected between them, they could in principle be combined into one data packet. However, in this example the resulting data block (DP 2 +DP 3) should be larger than the available working memory 103.10. However, since a data packet must initially be entirely received, this presents an unsolvable problem of the lack of working memory. For this reason the size of the working memory 103.10 is to be taken into account during the packeting process and DP 2 and DP 3 are transferred as separate data blocks.

As mentioned, the load state information already described above comprises a start address which identifies the address of one of the data packets 106.1 though 106.7. This data packet can be either the beginning of the continuation of a previously interrupted (and therewith incomplete) transfer of data packets, which continuation is desired by the franking machine 103, or the last successfully stored data packet after which it should be restarted unless the start address of the load state information is a special end identifier known to the server, which end identifier identifies a successfully concluded previous storage procedure.

The server uses this start address of the load state information and with it composes the firmware packet 106, thus the packet header 106.8 together with the sequence of data blocks 106.1 through 106.7 in the manner described above. In the composition of the firmware packet 106 a so-called transfer code is placed in the packet header 106, which transfer code identifies a new transfer or a continuation of an interrupted transfer. As is explained in detail in the following, this transfer code represents erasure information that identifies the memory segments of the memory 103.2 that are to be erased in the course of the further load procedure.

In a step 105.5 the packet header 106.8 is now initially transferred from the server of the data center 102 to the franking machine 103. The franking machine 103 analyzes the packet header 106.8. If the identification data of the firmware contained in the packet header 106.8 relates to current firmware loaded in the franking machine 103 or a correct successor (replacement) to this and if the range of the firmware that is defined by the start address and end address contained in the packet header 106.8 is a valid range for the firmware, among other things the transfer code is evaluated in a step 105.6.

In the event that the transfer code identifies a new transfer, in a step 105.8 the memory sectors 103.11 through 103.15 are erased which comprise the region that is defined by the start address and end address of the firmware.

In the event that the transfer code identifies a continuation transfer, in a step 105.7 it is checked whether the data packet identified by the load state information was successfully stored. If this is not the case, in the step 105.8 the sectors from the start address contained in the packet header to the end address of the firmware are not erased; rather, the sectors are erased from an interim start sector up to an interim end sector that are initially calculated by the franking machine 103 in the step 105.8. The interim start sector is the memory sector that contains the end address of the last written data packet, thus the end address from the load state information. The interim end sector is the sector that contains the end address of the firmware. The franking machine has persistently stored these addresses in the last transfer, as is explained in detail in the following.

After the corresponding sectors have possibly been erased in the step 105.8, the processing of the packet header 106.8 is next confirmed to the server. After the server of the data center 102 has received the confirmation, it sends (as is explained in detail in the following) the sequence of the data packets 106.1 through 106.7 and waits after every data packet for a confirmation that signals a successful processing.

In a step 105.9 a first data packet of the sequence is transmitted from the server of the data center 102 to the franking machine 103. The sequence begins with the first data packet 106.1 given a new transfer and, in the case of a continuation of an interrupted transfer, it begins with the data packet whose start address corresponds to the address that the server has extracted from the load state information.

As can be seen from FIG. 4B (the points 107.1 through 107.3 thereby represent the connection points between FIGS. 4A and 4B), in a step 105.10 the franking machine 103 initially undertakes an analysis of the received data packet as to its validity. Among other things, it is checked whether the start address lies in a region reserved or, respectively, segmented for firmware. This is required since otherwise regions of other, already present firmware parts could be overwritten or erased. A decompression is also possibly a further part of the analysis insofar as the data are identified by the server as compressed. The CRC of the data block is also checked and a CRC and HASH formed over the entire firmware are updated. The CRC and the HASH are formed over the entire firmware, whereby all data (from the start address to the end address of the packet header 106.8) from the data packets as well as from the gaps that occur are included.

The gap calculation is dependent on the memory technology used and the result after an erasure procedure. If a FLASH memory is used as a persistent memory (for example as in the present example), the latter is filled with 0×FF after an erasure procedure. In this case one 0×FF is inserted for each address of a gap.

As a last step of the analysis the position of the data packet is determined in the step 105.10. If the analysis has successfully concluded, the data packet is stored at a suitable position in a step 105.11. Otherwise the data transfer is interrupted.

As described above, the memory position of the data packet can already be the start address contained in the data packet but can also be a following address in a buffer. In the event that the data packet is immediately stored at its start address, this in principle ensues in an uncompressed manner since only in this way an execution by the processor 105.1 is ensured.

In the event that the data packet is initially stored in the buffer 103.9 as in the present example, this advantageously ensues in a compressed manner in order to be able to keep the buffer 103.9 as small as possible.

In a step 105.12 it is then checked whether the storage of the data packet was successful. After the successful storage of the data packet the load state information is updated in a step 105.13. Otherwise the data transfer is interrupted.

As mentioned above, dependent on the design of the implementation the load state comprises, for example, a start address and an end address. At the beginning of a new transfer these addresses are set to a predetermined first identifier. In the event that they do not contain this first identifier, in the present example they mark a data packet that was already successfully stored and has been written as the first one to a previously erased sector.

In the example from FIG. 3, the addresses of the data packet 106.1 (DP 1) could initially be stored since the data packet 106.1 (DP 1) is the first data packet that writes to the first memory sector 103.11. The addresses of the data packet 106.2 (DP 2) are never stored since the data packet 106.2 (DP 2) never writes as a first data packet to a previously erased memory sector. The addresses of the data packet 106.3 (DP 3) could be subsequently stored since the data packet (DP 3) is the first data packet that writes to the second memory sector 103.12. The data packet 106.5 (DP 5) is the first data packet which writes to the third memory sector 103.13 and the data packet 106.6 (DP 6) is the first data packet which writes to the fourth memory sector 103.14.

In the event that the start address or end address of a stored data packet lie in a memory sector that was not yet written to during the previous transfer, the start address and the end address are thus stored in the load state information. The end address of a data packet either can be determined from the start address and the size of the data packet or possibly be read out directly from the data packet.

The determination of whether a memory sector was already written to can be effected in different ways; for example, a sector number in the load state information can thus provide information about which consecutive memory sector was already written. A list of written memory sectors is likewise possible. However, it is also possible to dynamically determine the corresponding memory sector using the start address and end address already contained in the load state information. Moreover, a further start address and end address can be persistently stored that identify the last written data packet.

In this manner the load state information always identifies a data packet that marks a critical section in the event of a interruption of the transfer between the data center 102 and the franking machine 103. In the event of an interruption of the transfer, which data packets must imperatively be re-transferred must be determined dependent on the load state information.

Since an interruption of the transfer during storage of the data packets can lead to arbitrary undefined states in the last written address space, dependent on the memory technology that is used and that is organized in segments the last written memory sector must be erased. Since the sector limits of the memory sectors 103.11 through 103.14 do not necessarily coincide with the boundaries of the data packets 106.1 through 106.7, under certain circumstances a number of already successfully transferred data packets are wholly or partially lost due to the erasure procedure of a memory sector.

Since the load state information always identifies a data packet that as first has written to a previously erased memory sector and the data packets always exhibit a predetermined sequence of the start addresses (in the present example their start addresses increase in a strongly monotonic manner), this data packet identified by the load state information is a safe candidate for a continuation of the transfer.

In the present example an interruption of the transfer shall have occurred in a preceding load step during the transfer of the data packet 106.4 (DP 4). As was explained above, the load state information therefore initially reflects the start address and the end address of the data packet 106.3 (DP 3). In the step 105.8 the memory sectors 103.12 through 103.15 are therefore erased. The transfer of the data packets then begins in the step 105.9 with the data packet (DP 3).

It is understood that the portion of the data packet 106.3 (DP 3) located in the memory sector 103.11 is detected upon the storage of the data packet 106.3 (DP 3) and is taken into account in the storage, such that the data packet 106.3 (DP 3) is exactly continued again in the memory sector 103.12. Furthermore, for the case that the memory technology used does not support such a procedure, it is understood that a corresponding modification of the detection of the load state information must be made. As is preferable, the load state information then identifies only such data packets whose start address likewise lies in a memory sector that is written to as first by this data packet.

In the event that it is not known which memory sectors of the memory 103.2 were already written to, given continuation of the transfer all memory sectors between an interim start sector and an interim end sector should be erased. The interim end sector, thus the last memory sector to be erased, is determined as previously with the aid of the end address of the firmware packet 106, which end address is contained in the packet header 106.8. The interim start sector is the sector that comprises the end address from the load state information.

If the load state information was updated in the step 105.13, a confirmation that signals a successful processing of the appertaining data packet is transmitted from the franking machine 103 to the server of the data center 102.

In a step 105.14 it is subsequently checked whether a further data packet is pending for transfer. If this is the case, the method jumps back to the step 105.9 and is continued with the next data packet in the manner described above.

After the successful storage of the last data packet 106.7 of the firmware packet 106 in the step 105.13, the start address and the end address of the load state information are thereby set to a predetermined second identifier which identifies a successful conclusion of the load step 105.15 comprising the steps 105.9 through 105.14.

The franking machine now receives all data blocks in turn (sequentially). Each of these data blocks is analyzed, stored, a load state is updated and, after successful processing, this is confirmed to the server. This procedure is repeated until all data blocks have been successfully transferred from the server to the franking machine and have been confirmed by this. Last, the load state is verified by the franking machine and is marked as valid. Among other things, the specific end identifier is written as the start address in this marking.

If all data blocks have been transferred, the franking machine 103 is required by the server of the data center 102 to execute a concluding check or verification in a step 105.16. For this the franking machine 103 compares the CRC from the packet header 106.8 with the CRC that it has determined across the entire address space according to the method specified above. These must be identical in the present example for a successful check.

The HASH likewise determined and the digital signature contained in the packet header 106.8 are also used in order to verify the transfer with the aid of a known key.

If both checks are successful, the result is confirmed to the server of the data center 102 by the franking machine 103 and the transfer and the connection are ended in a step 105.17.

The achieved state of the running service is displayed to the user of the franking machine 103 via the user interface 103.5. It is understood that such a display can also ensue continuously, for example as a progress indication.

Dependent on the method used, the new firmware is either subsequently executed directly or, as in the present example, it is branched to the load part. In the latter case, the load part initially reorganizes the memory 103.2 correspondingly in that the data packets 106.1 through 106.7 are copied from the buffer 103.9 (possibly decompressed) into the address space provided for them in memory region 103.8 for the main function part. This procedure can be interrupted at any time since it can be repeated arbitrarily often and in particular without high time expenditure.

In a step 105.18 it is then checked whether the method workflow should be ended. If this is not the case, the method jumps back to the step 105.2. Otherwise the method workflow is ended in a step 105.19.

It is understood that the method described in the preceding with the buffering of the data packets in the buffer 103.9 requires a correspondingly large amount of persistent memory. However, it enables the processing of the transfer using the current main function part of the firmware since this is not overwritten during the transfer. However, it is understood that in other variants of the invention a processing of the transfer is likewise possible using the load part of the firmware. The latter execution increases the load part of the firmware, however requires no buffer since data which is accessed or, respectively, must be accessed to process the transfer can be stored directly in the desired persistent memory (addressed by start address of the respective data blocks) without overwriting.

The memory described in the preceding of the security module 105 or of the base module 104 can be fashioned wholly or in part both as separate memory modules and merely as individual memory regions of a single memory module.

Although the present invention was described in the preceding using the example of a franking machine, it is understood that it can also be used in connection with any other type of embedded system.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for loading data from a transmitter device into a non-volatile memory of a receiver device in communication with said transmission device, said non-volatile memory being comprised of a plurality of sectors and being erasable only sector-by-sector, said method comprising the steps of:
at said transmission device, dividing data to be loaded into a plurality of data packets;
transmitting said data from said transmission device to said receiver device, and loading transmitted data into said memory in a current loading step;
before implementing said current loading step, checking a current load state of said memory to identify whether at least a portion of said data packets have already been successfully loaded into the memory in a preceding loading step that precedes said current loading step; and
automatically electronically determining data packets to be loaded into said memory in said current loading step dependent on said current load state.

2. A method as claimed in claim 1 comprising in said current loading step:
erasing at least one memory sector of said memory dependent on said current load state.
transmitting only data packets for said at least one memory sector of said memory that has been erased dependent on said current load state and data packets that have not yet been successfully loaded into said memory, and
loading into said memory said data packets for said at least one sector of said memory that has been erased dependent on said current load state and said data packets that have not yet been successfully loaded into said memory.

3. A method as claimed in claim 1 comprising generating load state information identifying said current load state of said memory and non-volatily storing said load state information in said memory after successful loading of at least one of said data packets into said memory.

4. A method as claimed in claim 3 comprising generating and non-volatily storing said load state information in said memory after each successful loading of a data packet.

5. A method as claimed in claim 3 comprising non-volatily storing a load state information representing a successful completion of said loading step in said memory after successful loading of a last of said data packets into said memory.

6. A method as claimed in claim 1 comprising:
checking said current load state by interrogating a load state information stored in said preceding loading step,
said load state information of said preceding loading step identifying at least one data packet that was successfully loaded into said memory in said preceding loading step.

7. A method as claimed in claim 6 comprising including in said load state information at least one memory address of said data packet that was successfully loaded into said memory in said preceding loading step.

8. A method as claimed in claim 7 comprising including in said load state information a start address of said data packet that was successfully loaded into said memory in said preceding loading step, and at least one of an end address and size information of said data packet that was successfully loaded into said memory in said preceding loading step.

9. A method as claimed in claim 8 comprising employing a last data packet that was loaded into said memory in said preceding loading step as said data packet that was successfully loaded into said memory in said preceding loading step.

10. A method as claimed in claim 1 wherein data loaded into said memory in said preceding loading step have a preceding data version and data to be loaded into said memory in said current loading step have a current data version, and comprising:
for implementing said current loading step, additionally making a version comparison between said preceding data version and said current data version; and
implementing said current loading step only if said current data version is more current than said preceding data version, or only if a load instruction initiating said current loading step exists.

11. A method as claimed in claim 1 comprising:
at said transmitter device, associating verification data with at least some of said data packets to be transmitted to said receiver device before said current loading step; and
at said receiver device verifying at least one of completeness, integrity and authenticity of said at least some of said data packets using said verification data.

12. A method as claimed in claim 1 comprising, at said transmitter device, compressing at least some of said data packets and transmitting said at least data packets to said receiver device in compressed form.

13. A method as claimed in claim 1 comprising transmitting said data packets from said transmitter device to said receiver device via a communication link, and dividing said data into said data packets dependent on at least one of said communication link, a computation capacity of said receiver device and a memory capacity of said receiver device.

14. A method as claimed in claim 13 comprising, at said transmitter device, automatically electronically determining, dependent on at least one of said communication link, said computation capacity of said receiver device and said memory capacity of said receiver device, whether at least some of said data packets should be compressed and, if so, compressing said at least some of said data packets.

15. A method as claimed in claim 1 comprising, in said current loading step, loading said data packets into respective locations in said memory selected from the group consisting of an ultimate location in said memory for the respective data packet, and a location in a buffer of said memory for subsequent transfer to an ultimate location of the respective data packet in said memory.

16. A method as claimed in claim 1 comprising, in said current loading step, for a first of said data packets to be loaded into said memory in said current loading step, erasing at least a sector of said memory in which at least a part of said first data packet is to be loaded before loading said first data packet.

17. A method as claimed in claim 16 comprising:
at said transmitter device, generating erasure information dependent on said current load state of said memory, which identifies a memory sector of said memory to be used in said current loading step;
transmitting said erasure information from said transmitter to said receiver device; and
at said receiver device, erasing said memory sector dependent on said erasure information.

18. A method as claimed in claim 17 comprising:
at said receiver device, generating load state information representing said current load state and, in said load state information, identifying a last data packet that was successfully loaded into said memory in said preceding loading step and that was written as a first data packet into a memory sector that was previously erased, and making said load state information available to said transmitter device; and
at said transmitter device, generating said erasure information to cause erasure of said memory sector of said memory into which said last data packet was successfully loaded in said preceding loading step.

19. An arrangement for loading data comprising:
a transmitter device;
a receiver device in communication with said transmission device, said receiver device having a non-volatile memory comprised of a plurality of sectors and being erasable only sector-by-sector;
said transmission device dividing data to be loaded into said memory of said receiver device into a plurality of data packets;
upon transmission of said data from said transmission device to said receiver device, said receiver device loading the transmitted data into said memory in a current loading step and before implementing said current loading step, checking a current load state of said memory to identify whether at least a portion of said data packets have already been successfully loaded into the memory in a preceding loading step that precedes said current loading step, and transmitting said current load state to said transmitter device; and
said transmitter device automatically electronically determining data packets to be transmitted and loaded into said memory in said current loading step dependent on said current load state.

20. An arrangement as claimed in claim 19 comprising
said transmission device being configured to erase at least one memory sector of said memory dependent on said current load state;
said transmission device being configured to transmit only data packets for said at least one memory sector of said memory that has been erased dependent on said current load state and data packets that have not yet been successfully loaded into said memory, and
said receiver device being configured to load into said memory said data packets for said at least one sector of said memory that has been erased dependent on said current load state and said data packets that have not yet been successfully loaded into said memory.

21. An arrangement as claimed in claim 19 wherein said receiver device generates load state information identifying said current load state of said memory and non-volatily stores said load state information in said memory after successful loading of at least one of said data packets into said memory.

22. An arrangement as claimed in claim 21 wherein said receiver device generates and non-volatily stores said load state information in said memory after each successful loading of a data packet.

23. An arrangement as claimed in claim 21 wherein said receiver device non-volatily stores a load state information representing a successful completion of said loading step in said memory after successful loading of a last of said data packets into said memory.

24. An arrangement as claimed in claim 22 wherein said receiver device checks said current load state by interrogating said load state information stored in said preceding loading step, said load state information of said preceding loading step identifying at least one data packet that was successfully loaded into said memory in said preceding loading step.

25. An arrangement as claimed in claim 24 wherein said receiver device includes in said load state information at least one memory address of the data packet that was successfully loaded into the memory in said preceding loading step.

26. An arrangement as claimed in claim 25 wherein said receiver device includes in said load state information a start address of said data packet that was successfully loaded into said memory in said preceding loading step, and at least one of an end address and size information of said data packet that was successfully loaded into said memory in said preceding loading step.

27. An arrangement as claimed in claim 26 wherein said receiver device employs a last data packet that was loaded into said memory in said preceding loading step as said data packet that was successfully loaded into said memory in said preceding loading step.

28. An arrangement as claimed in claim 19 wherein data loaded into said memory in said preceding loading step have a preceding data version and data to be loaded into said memory in said current loading step have a current data version, and wherein, for implementing said current loading step, said receiver device additionally makes a version comparison between said preceding data version and said current data version, and implements said current loading step only if said current data version is more current than said preceding data version, or only if a load instruction initiating said current loading step exists.

29. An arrangement as claimed in claim 19 wherein said transmitter device associates verification data with at least some of said data packets to be transmitted to said receiver device before said current loading step, and wherein said receiver device verifies at least one of completeness, integrity and authenticity of said at least some of said data packets using said verification data.

30. An arrangement as claimed in claim 19 wherein said transmitter device compresses at least some of said data packets and transmits said at least data packets to said receiver device in compressed form.

31. An arrangement as claimed in claim 19 wherein said transmitter device transmits said data packets from said transmitter device to said receiver device via a communication link, and divides said data into said data packets dependent on at least one of said communication link, a computation capacity of said receiver device and a memory capacity of said receiver device.

32. An arrangement as claimed in claim 31 wherein said transmitter device automatically electronically determines, dependent on at least one of said communication link, said computation capacity of said receiver device and said memory capacity of said receiver device, whether at least some of said data packets should be compressed and, if so, compresses said at least some of said data packets.

33. An arrangement as claimed in claim 19 wherein said receiver device in said current loading step, loads said data packets into respective locations in said memory selected from the group consisting of an ultimate location in said memory for the respective data packet, and a location in a buffer of said memory for subsequent transfer to an ultimate location of the respective data packet in said memory.

34. An arrangement as claimed in claim 19 wherein said receiver device, in said current loading step, for a first of said data packets to be loaded into said memory in said current loading step, erases at least a sector of said memory in which at least a part of said first data packet is to be loaded before loading said first data packet.

35. An arrangement as claimed in claim 34 wherein said transmitter device generates erasure information dependent on said current load state of said memory, which identifies a memory sector of said memory to be used in said current loading step, and transmits said erasure information from said transmitter to said receiver device, and wherein said receiver device erases said memory sector dependent on said erasure information.

36. An arrangement as claimed in claim 35 wherein said receiver device generates load state information representing said current load state and, in said load state information, identifies a last data packet that was successfully loaded into said memory in said preceding loading step and that was written as a first data packet into a memory sector that was previously erased, and wherein said transmitter device generates said erasure information to cause erasure of said memory sector of said memory into which said last data packet was successfully loaded in said preceding loading step.

37. An arrangement as claimed in claim 19 wherein said receiver device is a franking machine and wherein said transmitter device is a remote postal data center.
